(19) United States
(12) Patent Application Publication
(10) Pub. No.: US 2023/0302566 A1
(43) Pub. Date: Sep. 28, 2023

(54) SPOT WELDING METHOD AND SPOT WELDING DEVICE

(71) Applicant: SUBARU CORPORATION, Tokyo (JP)

(72) Inventor: Masahiro YOKOI, Tokyo (JP)

(21) Appl. No.: 18/116,108

(22) Filed: Mar. 1, 2023

(30) Foreign Application Priority Data
Mar. 25, 2022 (JP) 2022-050344

(51) Int. Cl. B23K 11/11; B23K 11/36

(52) U.S. Cl. CPC B23K 11/115; B23K 11/36

(57) ABSTRACT

A spot welding method of spot welding a workpiece including a first panel, a second panel, a third panel, and a fourth panel stacked in sequence includes: conducting indirect spot welding for the first panel and the second panel to form a first weld zone where the first panel is joined to the second panel; conducting indirect spot welding for the third panel and the fourth panel to form a second weld zone where the third panel is joined to the fourth panel; and, after forming the first weld zone and the second weld zone, conducting direct spot welding for the workpiece to form a third weld zone where the second panel is joined to the third panel.

### CROSS-REFERENCE TO RELATED APPLICATIONS

The present application claims priority from Japanese Patent Application No. 2022-050344 filed on Mar. 25, 2022, the entire contents of which are hereby incorporated by reference.

### BACKGROUND

The disclosure relates to a spot welding method and a spot welding device welding multiple panels by carrying a current between electrodes.

Resistance welding for welding multiple stacked panels by heat generated by carrying a high current between the panels is known as a method of welding metal panels.

As spot welding that is one type of resistance welding, direct spot welding is frequently used. The direct spot welding is a method of carrying a current between a pair of electrodes opposed to each other with holding multiple stacked panels between the paired electrodes therebetween and pressurizing the panels. Furthermore, indirect spot welding is used when it is impossible to hold the multiple panels between the paired electrodes due to a shape or the like of the panels. The indirect spot welding is a method of carrying a current between the electrodes by pressurizing stacked regions of the panels by a welding electrode and abutting a grounding electrode on a region other than the stacked regions.

When the direct spot welding is used to spot weld four stacked panels, a welding failure occurs among the panels that are not in contact with the paired electrodes. To avoid the welding failure, a technique for joining four panels by a combination of the direct spot welding and the indirect spot welding has been developed.

For example, in a spot welding method described in Japanese Unexamined Patent Application Publication No. 2021-23945, direct spot welding is conducted for first to a structure of three stacked panels to form first welding points in the structure. Subsequently, one panel is stacked on this structure and indirect spot welding is conducted between this fourth panel and the structure to form second welding points. The second welding points are formed at positions that do not overlap the first welding points in a stacking direction to ensure an amount of current during current carrying.

### SUMMARY

An aspect of the disclosure provides a spot welding method of spot welding a workpiece including a first panel, a second panel, a third panel, and a fourth panel stacked in sequence. The spot welding method includes conducting indirect spot welding for the first panel and the second panel to form a first weld zone where the first panel is joined to the second panel; conducting indirect spot welding for the third panel and the fourth panel to form a second weld zone where the third panel is joined to the fourth panel; and, after forming the first weld zone and the second weld zone, conducting direct spot welding for the workplace to form a third weld zone where the second panel is joined to the third panel.

An aspect of the disclosure provides a spot welding device for use in the spot welding method. The spot welding device includes a first electrode, a second electrode, a third electrode, a fourth electrode, a first circuit, a second circuit, and a third circuit. The first electrode is configured to pressure and contact an outer surface of the first panel. The second electrode is disposed at a position deviating from a central axis of the first electrode. The second electrode is configured to pressurize and contact an outer surface of the second panel. The third electrode is opposed to the second electrode coaxially. The third electrode is configured to pressurize and contact an outer surface of the third panel. The fourth electrode is opposed to the first electrode coaxially. The fourth electrode is configured to pressurize and contact an outer surface of the fourth panel. The first circuit is configured to switch between (i) a current-carrying state between the first electrode and the second electrode and (ii) a non-current-carrying state between the first electrode and the second electrode. The second circuit is configured to switch between (i) a current-carrying state between the third electrode and the fourth electrode and (ii) a non-current-carrying state between the third electrode and the fourth electrode. The third circuit is configured to switch between (i) a current-carrying state between the first electrode and the fourth electrode and (ii) a non-current-carrying state between the first electrode and the fourth electrode.

### BRIEF DESCRIPTION OF TRIM DRAWINGS

The accompanying drawings are included to provide a further understanding of the disclosure and are incorporated in and constitute a part this specification. The drawings illustrate an embodiment and, together with the specification, serve to describe the principles of the disclosure.

FIG. 1 is a schematic diagram illustrating principal members of a spot welding device according to one embodiment of the disclosure.

FIG. 2 illustrates circuit configurations of the spot welding device.

FIG. 3 illustrates the circuit configurations of the spot welding device.

FIG. 4 illustrates the circuit configurations of the spot welding device.

FIG. 5 illustrates the circuit configurations of the spot welding device.

FIG. 6 is a cross-sectional view illustrating a state of joining four panels by a spot welding method according to the present embodiment.

FIG. 7 is a cross-sectional view illustrating a state of joining four panels by a spot welding method of the related art.

FIG. 8 illustrates circuit configurations of the spot welding device and a method of spot welding five panels.

### DETAILED DESCRIPTION

With the spot welding method described above, the first welding points where the three panels are welded and the second welding points where the fourth panel is welded are formed in different locations in a panel surface direction. This makes it difficult to conduct welding in multiple locations in a narrow range to increase a joint strength.

The disclosure has been made in light of the problems and an object of the disclosure is to provide a spot welding method and a spot welding device capable of increasing a joint strength.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

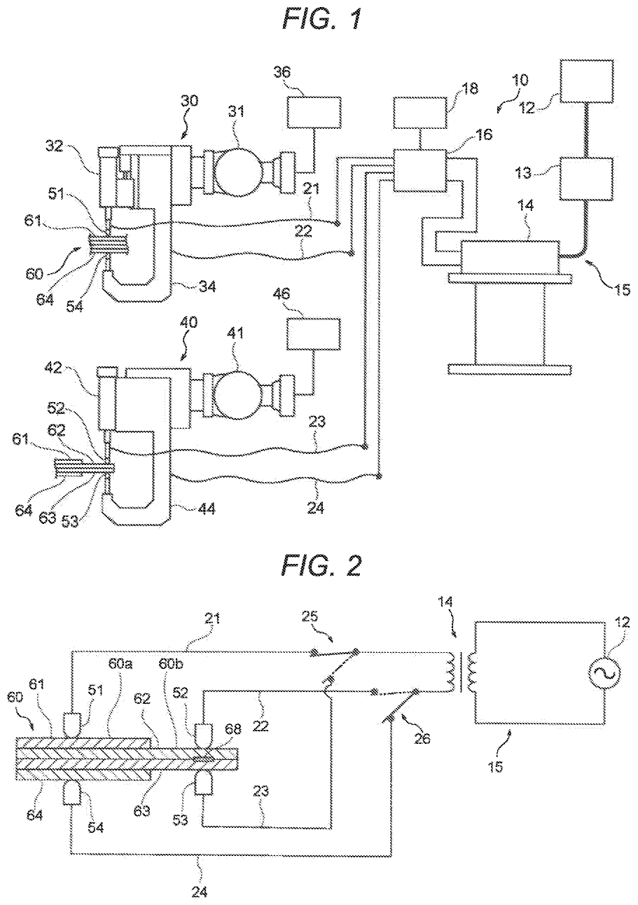

FIG. 1 is a schematic diagram illustrating principal members of a spot welding device 10 according to the embodiment of the disclosure. A spot welding device 10 is used in, for example, a manufacturing process (e.g., welding panels that configure a vehicle body) of a vehicle such as a motor vehicle. The spot welding device 10 is a device that can weld multiple metal panels overlapping at least partially. For example, the spot welding device 10 is suited for joining four stacked panels 61, 62, 63, 64.

FIG. 2 illustrates circuit configurations of the spot welding device 10. FIG. 2 also illustrates the four panels 61, 62, 63, 64 that are workpieces 60 to be welded (hereinafter, “workpiece 60”) and four electrodes 51, 52, 53, 54 of the spot welding device 10 that pressurize and contact the workpiece 60. In the present embodiment, stacked panels including the first panel 61 at the top, followed by the second panel 62, the third panel 63, and the fourth panel 64 in sequence are illustrated as an example of the workpiece 60 to be spot welded.

As illustrated in FIGS. 1 and 2, the workplace 60 has a joint region 60a where the four panels 61, 62, 63, 64 are stacked and a non-joint region 60b where the two intermediate panels 62, 63 out of the four panels 61, 62, 63, 64 are stacked. The four electrodes 51, 52, 53, 54 of the spot welding device 10 pressurize and contact the first to fourth panels 61, 62, 63, 64, respectively. In the present embodiment, it is defined that the electrode that contacts the first panel 61 is the first electrode 51, the electrode that contacts the second panel 62 is the second electrode 52, the electrode that contacts the third panel 63 is the third electrode 53, and the electrode that contacts the fourth panel 64 is the fourth electrode 54. The first electrode 51 and the fourth electrode 54 are opposed coaxially, and the second electrode 52 and the third electrode 53 are opposed coaxially.

According to the present embodiment, as illustrated in FIG. 2, an insulator 68 is disposed in a region held between paired electrodes 52, 53, to be described later, between the second panel 62 and the third panel 63 in the non-joint region 60b of the workpiece 60. The insulator 68 may be, for example, a rubber material or a weld bond and can be formed thin.

Configurations of the spot welding device 10 will next be described. As illustrated in FIG. 1, the spot welding device 10 includes a primary side power supply 12 and a welding transformer 14 that constitute a welding power supply 15, a switch box 16, a switch controller 18, a first welding gun 30, and a second welding gun 40, The first welding gun 30 includes the first electrode 51 and the fourth electrode 54, and the second welding gun 40 includes the second electrode 52 and the third electrode 53. The switch box 16 accommodates a first switch 25 and a second switch 26 illustrated in FIG. 2. The first switch 25 is coupled to a positive electrode side of the welding power supply 15 and the second switch 26 is coupled to a negative electrode side of the welding power supply 15.

The welding transformer 14 transforms a current from the primary side power supply 12 into a high current suited for spot welding and outputs the high current to the spot welding guns 30, 40. A welding current controller 13 lies between the primary side power supply 12 and the welding transformer 14. This welding current controller 13 controls welding current values supplied to the electrodes 51, 52, 53, 54 and current carrying time.

The first welding gun 30 is attached to a tip end of a first robot arm 31. The first welding gun 30 includes the first electrode 51 and the fourth electrode 54 opposed coaxially. The first electrode 51 is driven by a drive mechanism 32 to be movable axially. The fourth electrode 54 is fixed to a tip end of a gun arm 34 of the first welding gun 30. Alternatively, the first electrode 51 may be a fixed electrode, and the fourth electrode 54 may be a movable electrode. An axial moving action of the first electrode 51 and a holding force and a welding pressure by the first and fourth electrodes 51, 54 are under control of a first welding gun controller 36 coupled to the first welding gun 30.

The second welding gun 40 is attached to a tip end of a second robot arm 41. The second welding gun 40 includes the second electrode 52 and the third electrode 53 opposed coaxially. The second electrode 52 is driven by a drive mechanism 42 to be movable axially. The third electrode 53 is fixed to a tip end of a gun arm 44 of the second welding gun 40, Alternatively, the second electrode 52 may be a fixed electrode, and the third electrode 53 may be a movable electrode. An axial moving action of the second electrode 52 and a holding force and a welding pressure by the second and third electrodes 52, 53 are under control of a second welding gun controller 46 coupled to the second welding gun 40.

As illustrated in FIGS. 1 and 2, during spot welding, the drive mechanisms 32, 42 drive the first electrode 51 and the second electrode 52 to be closer to the fourth electrode 54 and the third electrode 53, respectively, in a state of mounting the workpiece 60. This enables the paired electrodes 51, 54 of the first welding gun 30 to pressurize and hold the joint region 60a of the workpiece 60, and the paired electrodes 52, 53 of the second welding gun 40 to pressurize and hold the non-joint region 60b of the workpiece 60.

Circuit configurations of the spot welding device 10 described above will next be described. As illustrated in FIGS. 1 and 2, the first electrode 51 is coupled to the welding power supply 15 via a first electrical line 21 and the first switch 25. The second electrode 52 is coupled to the welding power supply 15 via a second electrical line 22 and the second switch 26. The third electrode 53 is coupled to the welding power supply 15 via a third electrical line 23 and the first switch 25. The fourth electrode 54 is coupled to the welding power supply 15 via a fourth electrical line 24 and the second switch 26.

The first switch 25 performs a switching operation to couple the welding power supply 15 to either the first electrode 51 or the third electrode 53. The second switch performs a switching operation to couple the welding power supply 15 to either the second electrode 52 or the fourth electrode 54. The first switch 25 and the second switch 26 perform switching under control of the switch controller 18 illustrated in FIG. 1.

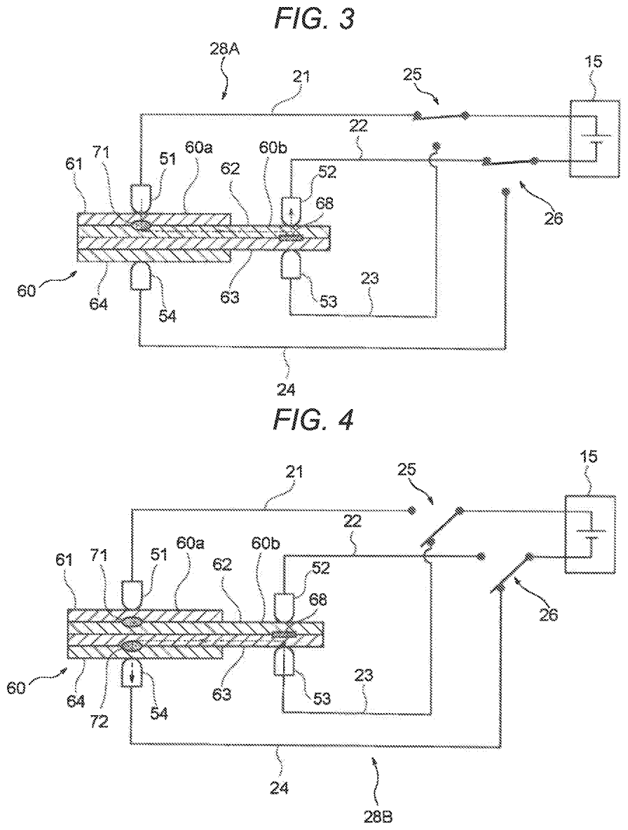

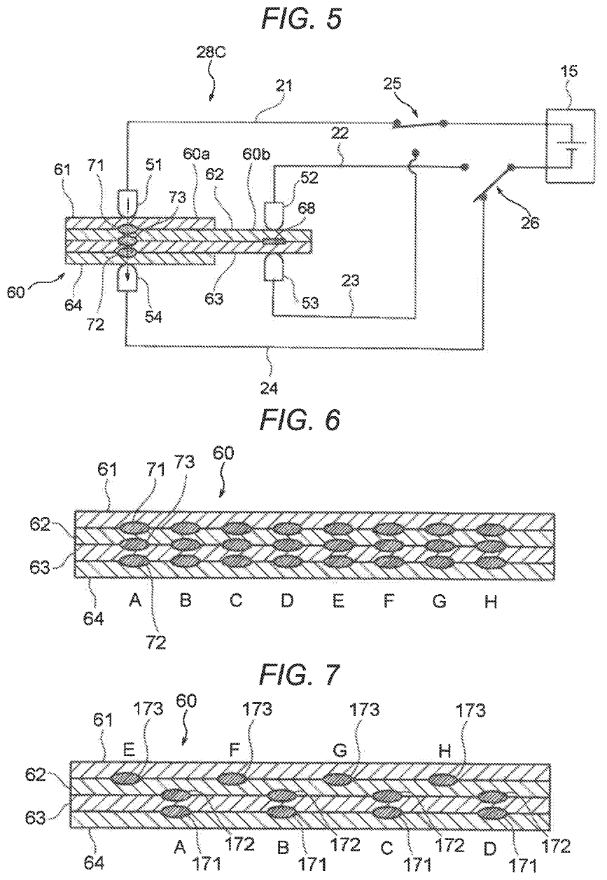

In the spot welding device 10 having the circuit configurations described above, the first switch 25 is coupled to the first electrical line 21 and the second switch 26 is coupled to the second electrical line 22 to form a first circuit 28A that electrically couples the first electrode 51 to the second electrode 52 as illustrated in FIG. 3. Furthermore, the first switch 25 is coupled to the third electrical line 23 and the second switch. 26 is coupled to the fourth electrical line 24 to form a second circuit 28B that electrically couples the third electrode 53 to the fourth electrode 54, as illustrated in FIG. 4. Moreover, the first switch 25 is coupled to the first electrical line 21 and the second switch 26 is coupled to the fourth electrical line 24 to form a third circuit 28C that electrically couples the first electrode 51 to the fourth electrode 54, as illustrated in FIG. 5. In the spot welding device 10, the switch controller 18 controls the switches 25, 26 to perform the switching operation, so that the first circuit 28A, the second circuit 26B, and the third circuit 28C can be each switched between a current-carrying state and a non-current-carrying state.

A spot welding method using the spot welding device 10 described above will next be described. As illustrated in FIG. 2, at a time of welding, the first electrode 51 of the spot welding device 10 pressurizes and contacts an outer surface of the first panel 61 and the fourth electrode 54 pressurizes and contacts an outer surface of the fourth panel 64 in the joint region 60a of the workpiece 60. In addition, the second electrode 52 of the spot welding device 10 pressurizes and contacts an outer surface of the second panel 62 in a way of deviating from a central axis of the first electrode 51 and the third electrode 53 pressurizes and contacts an outer surface of the third panel 63 in the non-joint region 60b of the workpiece 60.

In this state, the spot welding device 10 causes the switch controller 18 to switch a current-carrying circuit to the first circuit 28A illustrated in FIG. 3. At this time, the second circuit 28B and the third circuit 28C are in a non-current-carrying state. In this state, the spot welding device 10 carries a current between the first electrode 51 and the second electrode 52 to conduct indirect spot welding. As a result, a first weld zone 71 where the first panel 61 is joined to the second panel 62 is formed on an axis of the first electrode 51 as illustrated in FIG. 3.

Next, the spot welding device 10 causes the switch controller 18 to switch the current-carrying circuit to the second circuit 28B illustrated in FIG. 4. At this time, the first circuit 28A and the third circuit 28C are in a non-current-carrying state. In this state, the spot welding device 10 carries a current between the third electrode 53 and the fourth electrode 54 to conduct indirect spot welding. As a result, a second weld zone 72 where the third panel 63 is joined to the fourth panel 64 is formed on an axis of the fourth electrode 54 as illustrated in FIG. 4.

Next, the spot welding device 10 causes the switch controller 18 to switch the current-carrying circuit to the third circuit 28C illustrated in FIG. 5. At this time, the first circuit 28A and the second circuit 28B are in a non-current-carrying state. In this state, the spot welding device 10 carries a current between the first electrode 51 and the fourth electrode 54 to conduct direct spot welding. As a result, a third weld zone 73 where the second panel 62 is joined to the third panel 63 is formed on the axis of the first electrode 51, as illustrated in FIG. 5. Through these processes, the first weld zone 71, the second weld zone 72, and the third weld zone 73 are formed on the axes of the first and fourth electrodes 51, 54 to overlap one another in a stacking direction of the workpiece 60.

In the welding steps, the pressure applied to the workpiece 60 by the first electrode 51 and the fourth electrode 54 and the pressure applied to the workplace 60 by the second electrode 52 and the third electrode 53 can be set as appropriate. By way of example, in the spot welding device 10 according to the present embodiment, the pressure by the first electrode 51 and the fourth electrode 54 in the direct welding step is set higher than that in the first and second indirect welding steps. The pressure by the second electrode 52 and the third electrode 53 is set equal in all welding steps and set lower than the pressure by the first electrode 51 and the fourth electrode 54 in the direct welding steps. It is noted that the pressure by the first electrode 51 and the fourth electrode 54 and the pressure by the second electrode 52 and the third electrode 53 may be each set equal in all welding steps.

The spot welding method by the spot welding device 10 described above can maintain a state in which the electrodes 51, 52, 53, 54 are disposed at the same positions relative to the workpiece 60 and hold and pressurize the workpiece 60 in the first and second indirect welding steps and the direct welding step. In the present embodiment, the insulator 68 is placed between the second and third panels 62, 63 at the positions where the second and third electrodes 52, 53 hold the workpiece 60 therebetween. This can prevent the current from being carried between the second and third panels 62, 63 in the first and second indirect welding steps.

Furthermore, when conducting spot welding in multiple locations in the joint region 60a of the workpiece 60, the spot welding device 10 can efficiently conduct welding by changing merely the positions where the first and fourth electrodes 51, 54 hold the workpiece 60 therebetween without changing the positions where the second and third electrodes 52, 53 hold the workpiece 60 therebetween.

With the spot welding method described above, the resultant weld zones 71, 72, 73 overlap one another in the stacking direction of the workpiece 60, as illustrated in FIG. 5. Therefore, welding can be conducted in multiple locations in a narrow range of the workpiece 60, so that a joint strength of the workpiece 60 can be increased.

FIG. 6 is a cross-sectional view illustrating a state of joining the four panels 61, 62, 63, 64 by the spot welding method according to the present embodiment. FIG. 7 is a cross-sectional view illustrating a state of joining the four panels 61, 62, 63, 64 by a spot welding method of the related art. In FIGS. 6 and 7, A, B, C, D, E, F, and G indicate an order of forming the weld zones.

With the method of the related art illustrated in FIG. 7, direct spot welding is conducted for three panels (the second panel 62, the third panel 63, and the fourth panel 64) to form first weld zones 171 where the third panel 63 is joined to the fourth panel 64 and second weld zones 172 where the second panel 62 is joined to the third panel 63. Subsequently, one panel (the first panel 61) is stacked on the second panel 62 and indirect spot welding is conducted for the first panel 61 and the second panel 62 to form third weld zones 173 where the first panel 61 is joined to the second panel 62. With the method of the related art, for securing a current-carrying amount, the weld zones 171, 172 by the direct spot welding and the weld zones 173 by the indirect spot welding are formed in different locations in a surface direction of the workpiece 60.

The spot welding method according to the present embodiment, by contrast, forms the first weld zones 71, the second weld zones 72, and the third weld zones 73 such that the first weld zones 71, the second weld zones 72, and the third weld zones 73 overlap one another without being formed in different locations in the surface direction, as illustrated in FIG. 6. Therefore, more joint locations can be formed than those with the well-known method in a range of the same area. The joint strength of the workpiece 60 can be thereby increased.

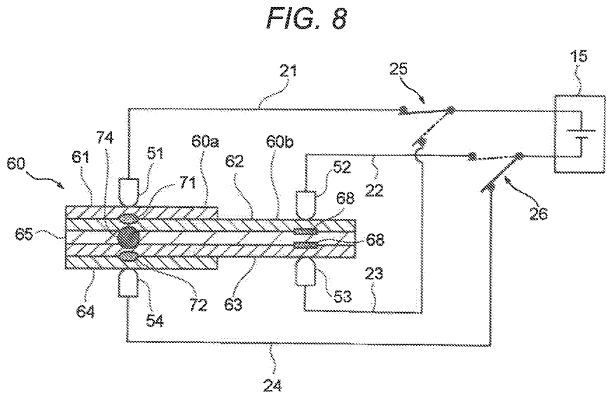

The spot welding device 10 described above is also applicable to joining five stacked panels. FIG. 8 illustrates circuit configurations of the spot welding device 10 and a method of spot welding five panels 61, 62, 63, 64, 65 according to another embodiment.

In an example illustrated in FIG. 8, the workpiece 60 is stacked panels including the first panel 61 at the top, followed by the second panel 62, the fifth panel 65, the third panel 63, and the fourth panel 64 in sequence. The workpiece 60 has a joint region 60a where the five panels 61, 62, 65, 63, 64 are stacked and a non-joint region 60b where the three panels 62, 65, 63 between the first and fourth panels 61, 64 are stacked. According to the present embodiment, insulators 68 are disposed in regions held between the second and third electrodes 52, 53 between the second panel 62 and the fifth panel 65 and between the fifth panel 65 and the third panel 63 in the non-joint region 60b of the workpiece 60.

When the five panels 61, 62, 63, 64, 65 are welded, a current is carried first between the first and second electrodes 51, 52 to conduct indirect spot welding for the first panel 61 and the second panel 62. As a result, the first weld zone 71 where the first panel 61 is joined to the second panel 62 is formed on the axis of the first electrode 51. Next, a current is carried between the third and fourth electrodes 53, 54 to conduct indirect spot welding for the third panel 63 and the fourth panel 64. As a result, the second weld zone 72 where the third panel 63 is joined to the fourth panel 64 is formed on the axis of the fourth electrode 54. Next, a current is carried between the first and fourth electrodes 51, 54 to conduct direct spot welding. As a result, a third weld zone 74 where the second, fifth, and third panels 61, 65, 62 are joined is formed on the axis of the first electrode 51. Thus, the weld zones 71, 72, 74 can be formed to overlap one another in the stacking direction of the workpiece 60.

The disclosure is not limited to the embodiments described above, and various changes and modifications may be made without departing from the spirit of the disclosure.

For example, with the spot welding method, after indirect spot welding is conducted for the third panel 63 and the fourth panel 64 to form the second weld zone 72, indirect spot welding may be conducted for the first panel 61 and the second panel 62 to form the first weld zone 71.

Furthermore, the insulator 68 is optional and spot welding can be conducted without using the insulator 68.

1. A spot welding method of spot welding a workpiece comprising a first panel, a second panel, a third panel, and a fourth panel stacked in sequence, the spot welding method comprising:
conducting indirect spot welding for the first panel and the second panel to form a first weld zone where the first panel is joined to the second panel;
conducting indirect spot welding for the third panel and the fourth panel to form a second weld zone where the third panel is joined to the fourth panel; and
after forming the first weld zone and the second weld zone, conducting direct spot welding for the workpiece to form a third weld zone where the second panel is joined to the third panel.

2. The spot welding method according to claim 1, wherein
the first weld zone, the second weld zone, and the third weld zone overlap one another in a stacking direction of the first panel, the second panel, the third panel, and the fourth panel.

3. The spot welding method according to claim 1, wherein
an electrode configured to pressurize and contact the second panel and an electrode configured to pressurize and contact with the third panel in the conducting indirect spot welding for the third panel and the fourth panel are opposed coaxially, and
in the conducting indirect spot welding for the first panel and the second panel and in the conducting indirect snot welding for the third panel and the fourth panel, an insulator is disposed between the second panel and the third panel and on an axis of each of the electrodes.

4. The spot welding method according to claim 2, wherein
an electrode configured to pressurize and contact the second panel and an electrode configured to pressurize and contact with the third panel in the conducting indirect spot welding for the third panel and the fourth panel are opposed coaxially, and
in the conducting indirect spot welding for the first panel and the second panel and in the conducting indirect spot welding for the third panel and the fourth panel, an insulator is disposed between the second panel and the third panel and on an axis of each of the electrodes.

5. The spot welding method according to claim 1, wherein
the workpiece further comprises a fifth panel stacked between the second panel and the third panel, and
the second panel, the fifth panel, and the third panel are joined by the direct spot welding in the conducting direct spot welding for the workpiece.

6. The spot welding method according to claim wherein
the workpiece further comprises a fifth panel stacked between the second panel and the third panel, and
the second panel, the fifth panel, and the third panel are joined by the direct spot welding in the conducting direct spot welding for the workpiece.

7. The spot welding method according to claim 3, wherein
the workpiece further comprises a fifth panel stacked between the second panel and the third panel, and
the second panel, the fifth panel, and the third panel are joined by the direct spot welding in the conducting direct spot welding for the workpiece.

8. The spot welding method according to claim 4, wherein
the workplace further comprises a fifth panel stacked between the second panel and the third panel, and
the second panel, the fifth panel, and the third panel are joined by the direct spot welding in the conducting direct spot welding for the workplace.

9. A spot welding device for use in the spot welding method according to claim 1, the spot welding device comprising:
a first electrode configured to pressure and contact an outer surface of the first panel;
a second electrode disposed at a position deviating from a central axis of the first electrode, the second electrode being configured to pressurize and contact an outer surface of the second panel;
a third electrode that is opposed to the second electrode coaxially, the third electrode being configured to pressurize and contact an outer surface of the third panel;
a fourth electrode that is opposed to the first electrode coaxially, the fourth electrode being configured to pressurize and contact an outer surface of the fourth panel;
a first circuit configured to switch between (i) a current-carrying state between the first electrode and the second electrode and (ii) a non-current-carrying state between the first electrode and the second electrode;
a second circuit configured to switch between (i) a current-carrying state between the third electrode and the fourth electrode and (ii) a non-current-carrying state between the third electrode and the fourth electrode; and
a third circuit configured to switch between (i) a current-carrying state between the first electrode and the fourth electrode and (ii) a non-current-carrying state between the first electrode and the fourth electrode.

10. A spot welding device for use in the spot welding method according to claim 2, the spot welding device comprising
a first electrode configured to pressure and contact an outer surface of the first panel;
a second electrode disposed at a position deviating from a central axis of the first electrode, the second electrode being configured to pressurize and contact an outer surface of the second panel;
a third electrode that is opposed to the second electrode coaxially, the third electrode being configured to pressurize and contact an outer surface of the third panel;
a fourth electrode that is opposed to the first electrode coaxially, the fourth electrode being configured to pressurize and contact an outer surface of the fourth panel;
a first circuit configured to switch between (i) a current-carrying state between the first electrode and the second electrode and (ii) a non-current-carrying state between the first electrode and the second electrode;
a second circuit configured to switch between (i) a current-carrying state between the third electrode and the fourth electrode and (ii) a non-current-carrying state between the third electrode and the fourth electrode; and
a third circuit configured to switch between (i) a current-carrying state between the first electrode and the fourth electrode and (ii) a non-current-carrying state between the first electrode and the fourth electrode.

11. A spot welding device for use in the spot welding method according to claim 3, the spot welding device comprising
a first electrode configured to pressure and contact an outer surface of the first panel;
a second electrode disposed at a position deviating from a central axis of the first electrode, the second electrode being configured to pressurize and contact an outer surface of the second panel;
a third electrode that is opposed to the second electrode coaxially, the third electrode being configured to pressurize and contact an outer surface of the third panel;
a fourth electrode that is opposed to the first electrode coaxially, the fourth electrode being configured to pressurize and contact an outer surface of the fourth panel;
a first circuit configured to switch between (i) a current-carrying state between the first electrode and the second electrode and (ii) a non-current-carrying state between the first electrode and the second electrode;
a second circuit configured to switch between (i) a current-carrying state between the third electrode and the fourth electrode and (ii) a non-current-carrying state between the third electrode and the fourth electrode; and
a third circuit configured to switch between (i) a current-carrying state between the first electrode and the fourth electrode and (ii) a non-current-carrying state between the first electrode and the fourth electrode.

12. A spot welding device for use in the spot welding method according to claim 4, the spot welding device comprising:
a first electrode configured to pressure and contact an outer surface of the first panel;
a second electrode disposed at a position deviating from a central axis of the first electrode, the second electrode being configured to pressurize and contact an outer surface of the second panel;
a third electrode that is opposed to the second electrode coaxially, the third electrode being configured to pressurize and contact an outer surface of the third panel;
a fourth electrode that is opposed to the first electrode coaxially, the fourth electrode being configured to pressurize and contact an outer surface of the fourth panel;
a first circuit configured to switch between (i) a current-carrying state between the first electrode and the second electrode and (ii) a non-current-carrying state between the first electrode and the second electrode;
a second circuit configured to switch between (i) a current-carrying state between the third electrode and the fourth electrode and (ii) a non-current-carrying state between the third electrode and the fourth electrode; and
a third circuit configured to switch between (i) a current-carrying state between the first electrode and the fourth electrode and (ii) a non-current-carrying state between the first electrode and the fourth electrode.
